(19) United States
(12) Patent Application Publication
(10) Pub. No.: US 2011/0279501 A1
(43) Pub. Date: Nov. 17, 2011

(54) INKJET PRINTER AND IMAGE RECORDING METHOD

(75) Inventor: Kiyoomi MITSUKI, Kyoto (JP)

(73) Assignees: SEIKO EPSON CORPORATION; DAINIPPON SCREEN MFG. CO., LTD.

(21) Appl. No.: 13/091,425

(22) Filed: Apr. 21, 2011

(30) Foreign Application Priority Data
May 12, 2010 (JP) P2010-110122

(51) Int. Cl. B41J 29/38

(52) U.S. Cl. 347/10

(57) ABSTRACT

In recording an image by an inkjet printer, when not forming a dot on a recording paper, non-ejection operation of droplet is performed in a head part by a non-ejection pulse (P21) which indicates the non-ejection operation and which is included in each driving signal, and when forming a medium dot, a droplet(s) is ejected from an outlet by the non-ejection pulse (P21) and an ejection pulse (P12) included in the driving signal. It is therefore possible to appropriately form dots having a desired size without adding any ejection pulse to the driving signal in high-speed image recording.

### TECHNICAL FIELD

The present invention relates to an inkjet printer for recording an image on an object and an image recording method performed in an inkjet printer.

### BACKGROUND ART

An inkjet printer is conventionally used, and in the inkjet printer, while a head part having a plurality of outlets is moved relative to an object, ejection of fine droplets of ink from each outlet is controlled to record an image. In the inkjet printer, for example, an ejection pulse is inputted to a piezoelectric element provided in the vicinity of each outlet in the head part to eject a droplet(s). In Japanese Patent Application Laid-Open No. 10-81012, disclosed is a technique where a driving signal outputted every printing period consists of four driving pulses which are a first pulse, a second pulse, a third pulse and a fourth pulse, and a diameter of recording dot on a recording paper is variably controlled to perform multi-level tone printing by appropriately selecting any one driving pulse or a plurality of driving pulses.

In Japanese Patent Application Laid-Open No. 2005-212411, disclosed is a technique where micro-vibration signals each of which causes micro-vibration of a meniscus in a nozzle at a level where ink in a channel is not ejected from the nozzle are applied to all channels continuously with or without image data, and ink ejection signals are generated in combination with the micro-vibration signals in accordance with image data, thereby to reliably record a high-quality image constantly.

Recently, high-speed image recording is required and a time cycle to input the driving signal to the head part becomes shorter. Thus, in the driving signal, a waveform of ejection pulse to cause ejection of droplet is limited, and there is a case where it is difficult to form a dot having a desired size by only one ejection pulse. By combination of a plurality of ejection pulses, formation of dot having a desired size is performed. However, in the case where a dot having each size is formed by a plurality of ejection pulses, a driving signal becomes long due to number of ejection pulses included therein, in the driving signal, and high-speed image recording can not be achieved.

### SUMMARY OF INVENTION

The present invention is intended for an inkjet printer. It is an object of the present invention to form dots appropriately even in high-speed image recording.

The inkjet printer according to the present invention comprises: a head part for forming dots on an object by ejecting droplets of ink from outlets toward the object, each of the dots having one of a plurality of sizes; a scanning mechanism for moving the object in a predetermined scanning direction relative to the head part; and a controller for sequentially inputting driving signals to the head part in parallel with relative movement of the object to the head part, each of the driving signals being applied for ejection operation of droplet; wherein in recording an image, when not forming a dot on the object, non-ejection operation of droplet is performed in the head part by a non-ejection pulse which indicates the non-ejection operation and which is included in each driving signal, when forming a dot having a first size of the plurality of sizes, a droplet(s) is ejected from an outlet by the non-ejection pulse and an ejection pulse included in the each driving signal, and when forming a dot having a second size of the plurality of sizes, a droplet(s) is ejected from an outlet by at least one ejection pulse which is included in the each driving signal and in which the non-ejection pulse is not included.

In the present invention, it is possible to appropriately form dots having the first size with application of the non-ejection pulse in high-speed image recording.

According to a preferred embodiment of the present invention, the each driving signal includes a plurality of basic waveform signals which are inputted to the head part in parallel, and each of the plurality of basic waveform signals includes a plurality of pulses, and a pulse(s) to be applied for forming a dot is extracted from the plurality of basic waveform signals in the head part. Therefore, the image can be recorded faster.

In the above case, preferably, the plurality of basic waveform signals are two basic waveform signals, each basic waveform signal consists of two pulses, and the plurality of sizes are two sizes, and when forming a dot having one size of the two sizes, two pulses out of four pulses included in the two basic waveform signals are applied, and when forming a dot having the other size of the two sizes, the other two pulses out of the four pulses are applied. As above, since dots having two sizes are formed with application of two pairs of pulses which are different from each other, adjustment of driving signal for formation of dot having each size can be performed easily.

More preferably, the second size is larger than the first size, and when forming a dot having the second size, two ejection pulses are applied.

It is preferable that the outlets are arranged across an entire width of a recording area on an object with respect to a direction orthogonal to the scanning direction.

The present invention is also intended for an image recording method performed in an inkjet printer.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a view showing a constitution of an inkjet printer;

FIG. 2 is a bottom plan view of a head part;

FIG. 3 is a block diagram showing a functional constitution of the inkjet printer;

FIG. 4 is a view showing a driving signal; and

FIG. 5 is a flowchart showing an operation flow for recording an image.

### DESCRIPTION OF EMBODIMENTS

FIG. 1 is a schematic view showing a constitution of an inkjet printer 1 in accordance with a preferred embodiment of the present invention. The inkjet printer 1 has a main body 10 and a computer 5 connected to the main body 10. The main body 10 has an ejection part 2 for ejecting fine droplets of ink toward a recording paper 9, a paper feeder 3 for moving the recording paper 9 toward the (−Y) direction in FIG. 1 at the lower side (the (−Z) side) of the ejection part 2, and a main body controller 4 connected to the ejection part 2 and the paper feeder 3.

The paper feeder 3 has two belt rollers 31 connected to a not-shown motor and a belt 32 hanging between the two belt rollers 31. Each portion of the recording paper 9, which is continuous paper, is guided onto the belt 32 through a roller 33 provided above the belt roller 31 at the (+Y) side to be held thereon and it is moved toward the (−Y) side, passing under the ejection part 2 together with the belt 32. An encoder 34 (see FIG. 3) is provided to the belt roller 31 of the paper feeder 3. In the following description, the moving direction (the Y direction) of the ejection part 2 relative to the recording paper 9 is referred to as the scanning direction. The paper feeder 3 may have a construction where a suction part is provided at a position, which is opposite to the ejection part 2, inside the loop-like belt 32 and very small suction holes are formed on the belt 32, to hold the recording paper 9 on the belt 32 by suction.

A head unit 21 having a plurality of head parts 23 (in the preferred embodiment, four head parts 23) is provided to the ejection part 2. The plurality of head parts 23 can eject ink of C (cyan), M (magenta), Y (yellow) and K (black), respectively, and they are arranged in the Y direction.

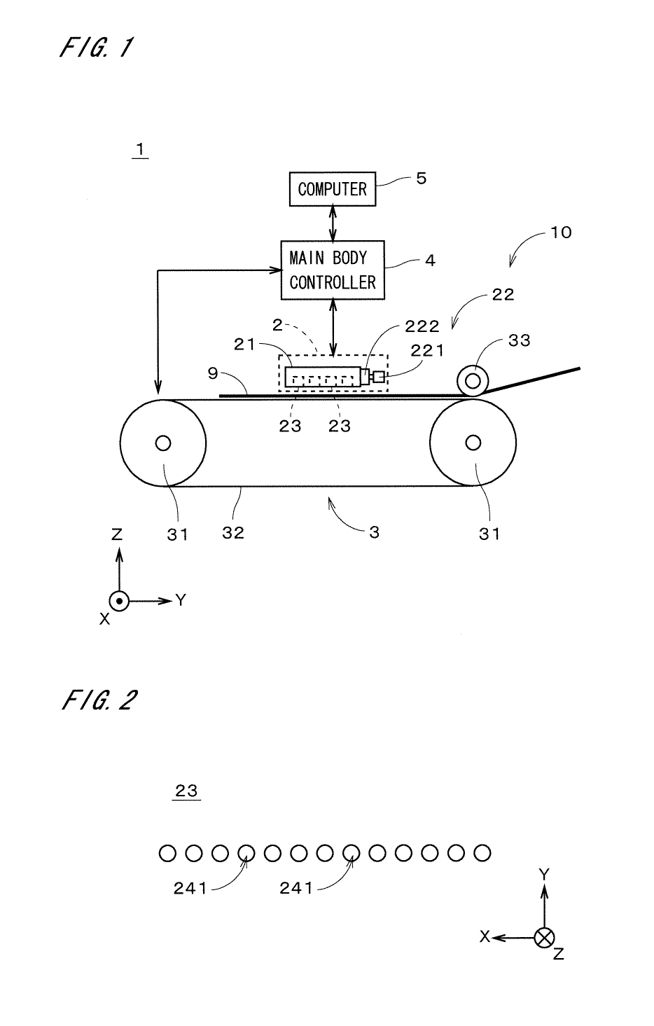

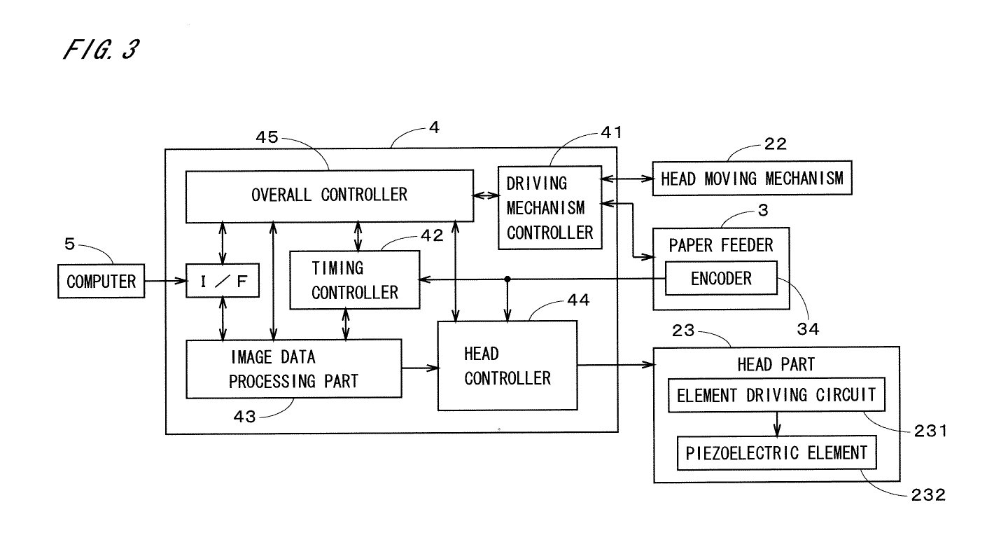

FIG. 2 is a bottom plan view showing one head part 23, and in FIG. 2, the scanning direction of the recording paper 9 relative to the ejection part 2 (i.e., the Y direction) is shown as a vertical direction. A plurality of outlets 241 are formed at the bottom surface of each head part 23 so as to be arranged at a constant pitch in a direction orthogonal to the scanning direction and along the recording paper 9 (i.e., the direction is the X direction in FIG. 1 and corresponds to the width of the recording paper 9, and hereinafter the direction is referred to as the “width direction”).

Piezoelectric elements 232 (see FIG. 3) are provided for respective outlets 241 in the head part 23. By driving the piezoelectric elements 232, droplets of ink are ejected from the outlets 241 toward the recording paper 9. Actually, each outlet 241 can eject different amounts of droplets by controlling drive of each piezoelectric element 232, and a medium sized dot and a large sized dot (hereinafter, referred to as the “medium dot” and the “large dot”) can be formed on the recording paper 9. The plurality of outlets 241 are arranged across the entire width of an recording area of the recording paper 9 with respect to the width direction, and image recording can be accomplished in a short time by one time passage of the recording paper 9 under the ejection part 2 (i.e., by one pass) in the inkjet printer 1.

The ejection part 2 illustrated in FIG. 1 has a head moving mechanism 22 for moving the head unit 21 in the width direction. The head moving mechanism 22 includes a timing belt 222 which has a long circular shape in the width direction, and the motor 221 rotates the timing belt 222 to move the head unit 21 smoothly in the width direction. During a time when recording process is not performed in the inkjet printer 1, the head moving mechanism 22 places the head unit 21 in a preset home position, where the plurality of outlets 241 in each head part 23 are closed with a cover member, to thereby prevent the outlets 241 from being clogged with dry ink in the vicinity of the outlets 241.

FIG. 3 is a block diagram showing a functional constitution of the inkjet printer 1. The main body controller 4 has a driving mechanism controller 41 for performing driving control of the head moving mechanism 22 and the paper feeder 3, a timing controller 42 which receives an encoder signal from the encoder 34 of the paper feeder 3 and controls a timing for ejection of droplets from the outlets 241 of the head part 23, an image data processing part 43 for generating writing data for the head parts 23 from an original image data which is inputted from the computer 5 via an interface (I/F) to be recorded, a head controller 44 which is connected to the head parts 23 and controls the head parts 23 on the basis of the writing data, and an overall controller 45 assigned to overall control of the main body controller 4. Note that a signal is inputted to each of the plurality of head parts 23 from the head controller 44 in practice, although only one head part 23 is illustrated in FIG. 3 for the convenience of illustration. The following description, which will be made about one head part 23 observed as an example, will hold true for all the head parts 23.

In the head part 23, an element driving circuit 231 is provided to the piezoelectric element 232 of each of the plurality of outlets 241, a value indicating a size of dot to be formed (there is a case where the value indicates not to form a dot, and the value is hereinafter referred to as the “output value”) and a predetermined driving signal which is applied for ejection operation of droplet (i.e., droplet ejection operation) are repeatedly inputted to each element driving circuit 231 from the head controller 44 at a constant period (cycle). In FIG. 3, only one element driving circuit 231 and one correspondent piezoelectric element 232 are illustrated.

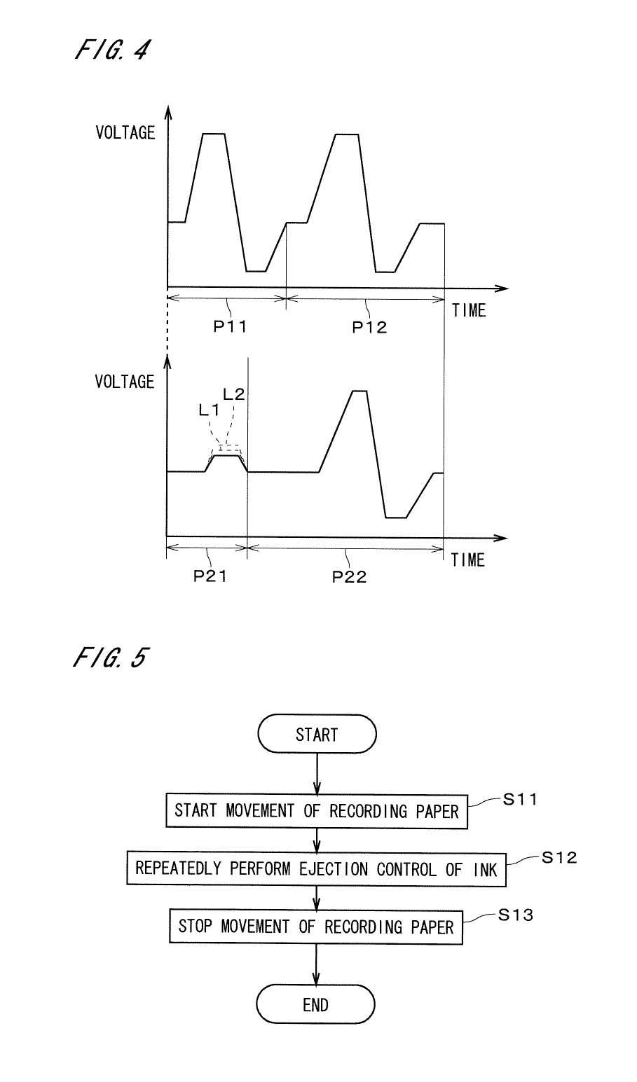

FIG. 4 is a view showing a driving signal inputted to the head part 23 from the head controller 44. In each of the upper part and lower part of FIG. 4, the vertical axis shows voltage and the horizontal axis shows time. The driving signal includes a plurality of basic waveform signals, and the basic waveform signal shown in the upper part of FIG. 4 and the basic waveform signal shown in the lower part of FIG. 4 are inputted to each head part 23 in parallel. Each basic waveform signal includes a plurality of pulses (in FIG. 4, two pulses). In the upper part of FIG. 4, periods of the two pulses are indicated by arrows denoted by reference signs P11, P12, and in the lower part of FIG. 4, periods of the two pulses are indicated by arrows denoted by reference signs P21, P22.

Each pulse is intended for making the piezoelectric element 232 perform a series of operation. As described later, the pulses in the periods P11, P12 shown in the upper part of FIG. 4 and the pulse in the period P22 shown in the lower part of FIG. 4 are intended for making the outlet 241 eject a droplet(s), and the pulse in the period P21 shown in the lower part of FIG. 4 is intended for making the outlet 241 perform a predetermined non-ejection operation. In the following description, the pulses in the periods P11, P12, P22 are referred to as the “ejection pulses P11, P12, P22” and the pulse in the period P21 is referred to as the “non-ejection pulse P21”. The maximum voltage (or an absolute value of voltage) in the non-ejection pulse P21 is lower than those in the ejection pulses P11, P12, P22.

In each element driving circuit 231 of the head part 23, a pulse(s) is extracted from the driving signal in accordance with the output value from the head controller 44, and the pulse(s) is inputted to the piezoelectric element 232 corresponding to the element driving circuit 231. Specifically, in the element driving circuit 231 to which the output value indicating not to form any dot is inputted, only the non-ejection pulse P21 is extracted from the driving signal to be outputted to the correspondent piezoelectric element 232. Therefore, micro-vibration at a level where any droplet is not ejected from the outlet 241 is performed as non-ejection operation in the piezoelectric element 232, and any dot is not formed on the recording paper 9.

In the element driving circuit 231 to which the output value indicating to form a large dot is inputted, the ejection pulses P11, P22 are extracted from the driving signal to be outputted to the correspondent piezoelectric element 232. Therefore, in the outlet 241 corresponding to the element driving circuit 231, droplet ejection operation corresponding to the ejection pulse P11 is first performed, and then droplet ejection operation corresponding to the ejection pulse P22 is performed, to form the large dot on the recording paper 9. Furthermore, in the element driving circuit 231 to which the output value indicating to form a medium dot is inputted, the non-ejection pulse P21 and the ejection pulse P12 are extracted from the driving signal to be outputted to the correspondent piezoelectric element 232. Therefore, in the outlet 241 corresponding to the element driving circuit 231, the non-ejection operation corresponding to the non-ejection pulse P21 is first performed, and then droplet ejection operation corresponding to the ejection pulse P12 is performed, to form the medium dot which is smaller than the large dot on the recording paper 9.

Extraction of the combination of the leading pulse P11 in the basic waveform signal shown in the upper part of FIG. 4 and the leading pulse P21 in the basic waveform signal shown in the lower part of FIG. 4, and extraction of the combination of the following pulse P12 in the basic waveform signal shown in the upper part of FIG. 4 and the following pulse P22 in the basic waveform signal shown in the lower part of FIG. 4 are made impossible.

FIG. 5 is a flowchart showing an operation flow for recording an image on the recording paper 9 by the inkjet printer 1. When image recording operation is started by the inkjet printer 1, first, the driving mechanism controller 41 drives the head moving mechanism 22, and thereby the head unit 21 in FIG. 1 is moved from the home position to a predetermined position remote from the home position in the X direction. Subsequently, the paper feeder 3 is driven to start continuous movement of the recording paper 9 (Step S11), the head controller 44 in FIG. 3 sequentially inputs the output values and the driving signals to the head part 23 in parallel with relative movement of the recording paper 9 to the ejection part 2, and thereby ejection control of ink is repeatedly performed (Step S12).

In detail, every time when the recording paper 9 is moved by a predetermined distance in the scanning direction, an ejection timing signal is generated by the timing controller 42 on the basis of pulses outputted from the encoder 34. The output value and the driving signal are inputted to each of the plurality of element driving circuits 231 from the head controller 44 in synchronization with the ejection timing signal, and therefore ejection control of ink is repeatedly performed.

As already described, in the outlet 241 where the output value indicating to form the large dot is inputted to its (correspondent) element driving circuit 231, the signal consisting of the two ejection pulses P11, P22 is inputted to its (correspondent) piezoelectric element 232. Therefore, the ejection operation of droplet by the ejection pulse P11 and the ejection operation of droplet by the ejection pulse P22 are performed in rapid succession (continuously in a short time), to form the large dot on the recording paper 9. In the outlet 241 where the output value indicating to form the medium dot is inputted to its element driving circuit 231, the signal consisting of the non-ejection pulse P21 and the ejection pulse P12 is inputted to its piezoelectric element 232. Therefore, the non-ejection operation by the non-ejection pulse P21 and the ejection operation of droplet by the ejection pulse P12 are performed in rapid succession, to form the medium dot on the recording paper 9. In the outlet 241 where the output value indicating not to form any dot is inputted to its element driving circuit 231, only the non-ejection operation by the non-ejection pulse P21 is performed, to prevent ink in the vicinity of the outlet 241 from becoming hardened.

As above, ejection control of ink is repeated, and therefore a whole image represented by the original image data to be recorded is recorded on the recording paper 9. After that, movement of the recording paper 9 is stopped and the image recording operation by the inkjet printer 1 is completed (Step S13).

In the inkjet printer 1, when determining a waveform of driving signal which is capable of forming the medium dot by the non-ejection pulse and the ejection pulse, voltage of non-ejection pulse P21 in a driving signal which has general waveforms of non-ejection pulse and ejection pulses is changed to a plurality of values, for example as shown by dashed lines denoted by reference signs L1, L2 in FIG. 4, thereby to prepare a plurality of driving signals. Then, while actual operation for forming the medium dot (i.e., the operation is non-ejection operation by the non-ejection pulse and ejection operation of droplet by the ejection pulse P12) is sequentially performed by using the plurality of driving signals in turn, observation results such as an ejection amount of the droplet, an ejection direction and an ejection speed are obtained, and therefore a definite (final) waveform of driving signal (i.e., the driving signal applied for the image recording) is determined. There may be a case where a definite driving signal is determined by changing a shape of ejection pulse, a time period between pulses or the like.

In a case of high-speed image recording by an inkjet printer, if a medium dot is formed by using only one ejection pulse, there is a case where it is difficult to form a dot having a desired size because a waveform of ejection pulse is limited with shortening of time period of driving signal. It is thought to form a dot having a desired size by a combination of a plurality of ejection pulses. However, in the case where a dot having each size is formed by a plurality of ejection pulses, a driving signal becomes long due to a rising number of ejection pulses included in the driving signal and high-speed image recording can not be achieved (i.e., it is impossible to respond to speeding up of image recording).

Correspondingly, in recording an image (i.e., during the image recording) by the inkjet printer 1, when not forming a dot on the recording paper 9, the non-ejection operation of droplet is performed in the head part 23 by the non-ejection pulse P21 which indicates the non-ejection operation of droplet and which is included in each driving signal, and when forming the medium dot, a droplet(s) is ejected from the outlet 241 by the non-ejection pulse P21 and the ejection pulse P12 included in the driving signal. As above, when forming the medium dot, an ink surface (meniscus surface) at the outlet 241 is vibrated by the non-ejection pulse P21, and subsequently ink is actually ejected from the outlet 241 by the ejection pulse P12. It is therefore possible to appropriately form dots having the desired size without further adding any ejection pulse to the driving signal, and an accurate image can be recorded faster. Here, the ejection pulse P12 and the non-ejection pulse P21 have shapes mutually optimized to form the medium dot. If ejection operation is performed by using only the ejection pulse P12 having the above shape, flight of droplet becomes turbulent and a dot having a normal shape is not formed.

In the inkjet printer 1, the driving signal consisting of the two basic waveform signals is applied and each basic waveform signal consists of two pulses. When forming a dot having one size of the two sizes, two pulses out of four pulses included in the two basic waveform signals are applied, and when forming a dot having the other size of the two sizes, the other two pulses out of the four pulses are applied. As above, since dots having two sizes are formed with application of two pairs of pulses which are different (independent) from each other, dedicated ejection pulses (or a pulse) can be set (or determined) for formation of dot having each size and adjustment of driving signal for formation of dot having each size can be performed easily.

Though the preferred embodiments of the present invention have been discussed above, the present invention is not limited to the above-discussed preferred embodiments, but allows various variations.

In the above inkjet printer 1, a trinary output value (any one of three tone values) which indicates to form the large dot, to form the medium dot or not to form any dot, is inputted to the head part 23 from the head controller 44. However, a quaternary or more output value may be inputted to the head part 23 in the case where dots having three or more sizes can be formed by the head part 23. For example, a dot having relatively smaller size (i.e., small dot) may be formed additionally in the inkjet printer 1 by using only the ejection pulse P11 included in the driving signal in FIG. 4 or by using a driving signal including three basic waveform signals or a driving signal where each basic waveform signal includes three pulses.

There may be a case where the large dot is formed by the non-ejection pulse and the ejection pulse and the medium dot is formed by only the ejection pulse. Furthermore, in the case where a large dot, medium dot and small dot can be formed, there may be a case where the large dot is formed by a non-ejection pulse and one ejection pulse, the medium dot is formed by the non-ejection pulse and another ejection pulse, and the small dot is formed by only an ejection pulse. As above, both the large dot and the medium dot or any one dot may be formed by the combination of the non-ejection pulse and the ejection pulse.

As described above, in the inkjet printer 1, when forming a dot(s) having at least one size out of a plurality of sizes, a non-ejection pulse and an ejection pulse included in a driving signal are applied, and when forming a dot(s) having a remaining size(s) other than the at least one size, at least one ejection pulse which is included in the driving signal and in which the non-ejection pulse is not included is applied. When forming a dot by pulses including the non-ejection pulse, the non-ejection pulse and two or more ejection pulses may be used (may be included in the pulses).

In the above preferred embodiment, since the driving signal including the plurality of basic waveform signals is inputted to the head part 23, the accurate image represented by dots having the plurality of sizes can be recorded faster (accurate image recording can be achieved with high speed). However, a driving signal including only one basic waveform signal may be applied in a certain recording speed required for image recording.

Although the recording paper 9 is moved relative to the head part 23 in the scanning direction by the paper feeder 3 which is a scanning mechanism in the inkjet printer 1, a scanning mechanism for moving the head part 23 in the Y direction may be provided. There also may be a case where the recording paper 9 is held on a roller and the recording paper 9 is moved relative to the head part 23 in the scanning direction by a motor for rotating the roller. As above, a scanning mechanism for moving the recording paper 9 in the scanning direction relative to the head part 23 can be implemented by various structures.

The inkjet printer may be a machine for recording an image on a recording paper which is a cut sheet. For example, in an inkjet printer where a recording paper is held on a stage, with respect to a width direction, a width within which a plurality of outlet in a head part are arranged is narrower than a width of a recording area of the recording paper, and a scanning mechanism for moving the head part relative to the recording paper in a scanning direction and the width direction is provided. The head part performs relative movement (main scanning) in the scanning direction while ejecting ink, and after arrival at an end of the recording paper, the head part performs relative movement (sub scanning) in the width direction by a predetermined distance. After that, the head part performs relative movement toward a side in the scanning direction, which is different from the side in the last main scanning, while ejecting ink. Thus, in the above inkjet printer, the head part performs the main scanning relative to the recording papers in the scanning direction, and intermittently performs the sub scanning in the width direction every time when the main scanning is completed, thereby to print an image on the whole recording paper. From a viewpoint where an image is recorded at high speed, it is preferred that the above technique to apply the non-ejection pulse for ejection of droplet is employed in so-called one pass type inkjet printer 1 where the image recording is accomplished by one time passage of the recording paper 9 under the head part 23.

In each head part 23, the plurality of outlets may be arranged in a horizontal direction which is inclined relative to the X direction. The plurality of outlets in the head part 23 may be arranged in a zigzag (staggered) manner.

An object in image recording by the inkjet printer 1 may be a plate-like or film-like base member formed of a material such as plastic or the like other than the recording paper 9.

The constituent elements of above-discussed preferred embodiments and respective modified examples may be appropriately combined with one another, as long as they are not mutually exclusive.

While the invention has been shown and described in detail, the foregoing description is in all aspects illustrative and not restrictive. It is therefore understood that numerous modifications and variations can be devised without departing from the scope of the invention. This application claims priority benefit under 35 U.S.C. Section 119 of Japanese Patent Application No. 2010-110122 filed in the Japan Patent Office on May 12, 2010, the entire disclosure of which is incorporated herein by reference.

### REFERENCE SIGNS LIST

1 inkjet printer
3 paper feeder
4 main body controller
9 recording paper
23 head part
241 outlet
P11, P12, P22 ejection pulse
P21 non-ejection pulse
S11 to S13 step

1. An inkjet printer, comprising:
a head part for forming dots on an object by ejecting droplets of ink from outlets toward said object, each of said dots having one of a plurality of sizes;
a scanning mechanism for moving said object in a predetermined scanning direction relative to said head part; and
a controller for sequentially inputting driving signals to said head part in parallel with relative movement of said object to said head part, each of said driving signals being applied for ejection operation of droplet; wherein
in recording an image,
when not forming a dot on said object, non-ejection operation of droplet is performed in said head part by a non-ejection pulse which indicates said non-ejection operation and which is included in each driving signal,
when forming a dot having a first size of said plurality of sizes, a droplet(s) is ejected from an outlet by said non-ejection pulse and an ejection pulse included in said each driving signal, and
when forming a dot having a second size of said plurality of sizes, a droplet(s) is ejected from an outlet by at least one ejection pulse which is included in said each driving signal and in which said non-ejection pulse is not included.

2. The inkjet printer according to claim 1, wherein
said each driving signal includes a plurality of basic waveform signals which are inputted to said head part in parallel, and each of said plurality of basic waveform signals includes a plurality of pulses, and
a pulse(s) to be applied for forming a dot is extracted from said plurality of basic waveform signals in said head part.

3. The inkjet printer according to claim 2, wherein
said plurality of basic waveform signals are two basic waveform signals, each basic waveform signal consists of two pulses, and said plurality of sizes are two sizes, and
when forming a dot having one size of said two sizes, two pulses out of four pulses included in said two basic waveform signals are applied, and when forming a dot having the other size of said two sizes, the other two pulses out of said four pulses are applied.

4. The inkjet printer according to claim 3, wherein
said second size is larger than said first size, and when forming a dot having said second size, two ejection pulses are applied.

5. The inkjet printer according to claim 1, wherein
said outlets are arranged across an entire width of a recording area on an object with respect to a direction orthogonal to said scanning direction.

6. The inkjet printer according to claim 2, wherein
said outlets are arranged across an entire width of a recording area on an object with respect to a direction orthogonal to said scanning direction.

7. The inkjet printer according to claim 3, wherein
said outlets are arranged across an entire width of a recording area on an object with respect to a direction orthogonal to said scanning direction.

8. The inkjet printer according to claim 4, wherein
said outlets are arranged across an entire width of a recording area on an object with respect to a direction orthogonal to said scanning direction.

9. An image recording method performed in an inkjet printer, wherein
said inkjet printer comprises a head part for forming dots on an object by ejecting droplets of ink from outlets toward said object, each of said dots having one of a plurality of sizes,
said image recording method comprising the steps of:
a) moving said object in a predetermined scanning direction relative to said head part; and
b) sequentially inputting driving signals to said head part in parallel with relative movement of said object to said head part, each of said driving signals being applied for ejection operation of droplet; wherein
in recording an image,
when not forming a dot on said object, non-ejection operation of droplet is performed in said head part by a non-ejection pulse which indicates said non-ejection operation and which is included in each driving signal,
when forming a dot having a first size of said plurality of sizes, a droplet(s) is ejected from an outlet by said non-ejection pulse and an ejection pulse included in said each driving signal, and
when forming a dot having a second size of said plurality of sizes, a droplet(s) is ejected from an outlet by at least one ejection pulse which is included in said each driving signal and in which said non-ejection pulse is not included.

10. The image recording method according to claim 9, wherein
said each driving signal includes a plurality of basic waveform signals which are inputted to said head part in parallel, and each of said plurality of basic waveform signals includes a plurality of pulses, and
a pulse(s) to be applied for forming a dot is extracted from said plurality of basic waveform signals in said head part.

11. The image recording method according to claim 10, wherein
said plurality of basic waveform signals are two basic waveform signals, each basic waveform signal consists of two pulses, and said plurality of sizes are two sizes, and
when forming a dot having one size of said two sizes, two pulses out of four pulses included in said two basic waveform signals are applied, and when forming a dot having the other size of said two sizes, the other two pulses out of said four pulses are applied.

12. The image recording method according to claim 11, wherein
said second size is larger than said first size, and when forming a dot having said second size, two ejection pulses are applied.

13. The image recording method according to claim 9, wherein
said outlets are arranged across an entire width of a recording area on an object with respect to a direction orthogonal to said scanning direction.

14. The image recording method according to claim 10, wherein
said outlets are arranged across an entire width of a recording area on an object with respect to a direction orthogonal to said scanning direction.

15. The image recording method according to claim 11, wherein
said outlets are arranged across an entire width of a recording area on an object with respect to a direction orthogonal to said scanning direction.

16. The image recording method according to claim 12, wherein
said outlets are arranged across an entire width of a recording area on an object with respect to a direction orthogonal to said scanning direction.
